(19) United States
(12) Patent Application Publication
(10) Pub. No.: US 2022/0253880 A1
(43) Pub. Date: Aug. 11, 2022

(54) APPARATUS FOR PROCESSING ITEM SALES INFORMATION AND METHOD THEREOF

(71) Applicant: Coupang Corp., Seoul (KR)

(72) Inventors: Seung Ho JEONG, Seoul (KR); Chun Kwon PARK, Seoul (KR); Byeong Yong LEE, Seoul (KR); Amit GROVER, Seoul (KR); Min Ji YOON, Seoul (KR); Jung Yeon NAM, Seoul (KR); Catherine CHANG, Seoul (KR)

(21) Appl. No.: 17/187,612

(22) Filed: Feb. 26, 2021

(30) Foreign Application Priority Data
Feb. 5, 2021 (KR) 10-2021-0016732

(51) Int. Cl. G06Q 30/02

(52) U.S. Cl. CPC G06Q 30/0213; G06Q 30/0222

(57) ABSTRACT

According to the present disclosure, there is disclosed a method of processing item sales information in an electronic apparatus, the method including receiving a selection input of a user for one or more items, providing first benefit information related to the one or more items, and providing a page related to subscription of a specific membership in response to reception of an input related to the first benefit information based on account information of the user not corresponding to the specific membership, in which the first benefit information includes first discount information that is provided based on the account information of the user corresponding to the specific membership.

### BACKGROUND

### Technical Field

The present disclosure relates to an apparatus for processing item sales information and a method thereof. In more detail, the present disclosure relates to an apparatus that receives a selection input for one or more items from a user, provides first benefit information related to the one or more items, and provides a page related to membership subscription in response to reception of an input related to the first benefit information when the account information of the user does not correspond to a specific membership, and a method thereof.

### Description of the Related Art

E-commerce has occupied a position as a field of shopping with development of the electronic technology. Customers can purchase items online even without going to shopping malls or markets in person and items purchased online are delivered to the shipping address requested by customers.

As for the process of e-commerce, a user may shop for items that are on sale through a terminal connected to the Internet such as a computer and may transmit an intention to purchase items to a seller. In this case, the transaction related to purchase of items may be processed by a payment method input by the user such as a credit card number or a password.

An administrator who manages a web site for online e-commerce may provide a membership related to item transactions on the website. A user may sign up for a membership by satisfying specific conditions set in advance such as paying a predetermined amount of money or more or paying a subscription fee or maintenance fee for the membership in order to purchase items. The administrator may provide the user who has signed up for a membership with membership benefits and the membership benefits may include benefits such as providing the user with convenience or advantages related to costs in relation to purchase of items.

However, in some cases, a user may not sign up for a membership because he/she does not recognize the existence of the membership or does not recognize membership benefits in detail. Further, a user who signed up for a membership may terminate the membership because he/she does not recognize the specific membership benefits that he/she has.

Accordingly, it may be necessary to expose membership benefits to users who do have not signed up for a membership and users who have signed up for a membership.

In relation to this, related art documents such as KR101498175B1 and KR101669630B1 may be referred to.

### SUMMARY

### Technical Goals

An aspect provides an apparatus that receives an selection input for one or more items from a user, provides first benefit information related to the one or more items, and provides a page related to membership subscription in response to reception of an input related to the first benefit information when the account information of the user does not correspond to a specific membership, and a method thereof.

However, the goals to be achieved by example embodiments of the present disclosure are not limited to the objectives described above and other objects may be inferred from the following example embodiments.

### Technical Solution

According to an aspect, there is provided a method of processing item sales information in an electronic apparatus including: receiving a selection input of a user for one or more items; providing first benefit information related to the one or more items; and providing a page related to subscription of a specific membership in response to reception of an input related to the first benefit information based on account information of the user not corresponding to the specific membership. The first benefit information includes first discount information that is provided based on the account information of the user corresponding to the specific membership.

Based on the account information of the user corresponding to the specific membership, the first benefit information may include information indicating that the account information of the user corresponds to the specific membership and delivery-related benefit information corresponding to the specific membership.

The first benefit information may include information indicating that the first discount information is provided based on the account information of the user corresponding to the specific membership.

The method may further include providing second benefit information which is irrelevant to the specific membership and includes second discount information related to the one or more items. The first benefit information and the second benefit information may be displayed in a first region and the second benefit information may be displayed at a lower level than the first benefit information.

The method may further include providing additional descriptive information including the first benefit information in response to the reception of the input related to the first benefit information based on the account information of the user corresponding to the specific membership.

The method may further include providing a payment page including a price, to which the first discount information has been applied, in relation to at least some of the one or more items in response to the reception of the input related to the first benefit information based on the account information of the user corresponding to the specific membership.

The method may further include providing a payment page that includes a price to which the first discount information has been applied in relation to at least some of the one or more items and on which a specific payment method is set as a payment method for paying for at least some of the one or more items, in response to the reception of the input related to the first benefit information based on the first discount information being a benefit that is applied based on the one or more items being purchased using the specific payment method and the account information of the user corresponding to the specific membership.

The first discount information may correspond to at least one benefit related to at least one payment method stored in advance in the account information of a user.

Price information to which the first discount information has been applied for at least some of the one or more items may be provided regardless of whether the account information of the user corresponds to the specific membership.

The method may further include: receiving a search input of a user; and providing an item search result in response to the search input. Based on the item search result including information related to a first item and the first item being related to the first benefit information, the information related to the first item may include the first benefit information.

The method may further include checking a balance of a budget allocated to provide the first benefit information. Item-related information to which the first benefit information has been applied may be provided based on the balance satisfying a specific condition, and item-related information to which the first benefit information has not been applied may be provided based on the balance not satisfying the specific condition.

Based on the first benefit information including a plurality of different benefits that are provided for a plurality of payment methods, the providing of the first benefit information may include determining a manner of showing the plurality of different benefits on a basis of a result comparing at least some of the plurality of different benefits.

Based on the first benefit information including one or more benefits that are provided for one or more payment methods, the providing of the first benefit information may include providing at least one benefit based on the at least one benefit related to at least one payment method being stored in advance in correspondence with the account information of the user among the one or more benefits, and based on no benefit related to at least one payment method being stored in advance in correspondence with the account information of the user among the plurality of different benefits, the first benefit information may not be provided.

The method may further include determining whether to provide second benefit information which is irrelevant to the specific membership and includes second discount information related to the item.

The determining of whether to provide the second benefit information may include: determining that the second benefit information is to be provided based on the first discount information and the second discount information being allowed to be simultaneously applied to purchase the one or more items; and based on the first discount information and the second discount information not being allowed to be simultaneously applied to purchase the one or more items, determining that the second benefit information is to be provided when determining that the account information of the user does not correspond to the specific membership, and determining that the second benefit information is not to be provided when determining that the account information of the user corresponds to the specific membership.

The method may further include providing a reduction or exemption benefit for a usage fee for the specific membership to the user for a predetermined period based on the user signing up for the specific membership on a basis of the page related to the subscription of the specific membership.

The method may further include: determining whether the user has been provided with a reduction or exemption benefit for a usage fee for the specific membership based on the user signing up for the specific membership on a basis of the page related to the subscription of the specific membership; and providing the reduction or exemption benefit to the user based on the user not having been provided with the reduction or exemption benefit. The reduction or exemption benefit may not be provided to the user again based on the user being provided with the reduction or exemption benefit.

The page related to the subscription of the specific membership may include information related to at least one item whose price is discounted based on the page being related to the one or more items and the account information of the user corresponding to the specific membership.

According to another aspect, there is also provided an electronic apparatus for selling items, the electronic apparatus including a transceiver, a memory in which instructions are stored, and a processor. The processor may be connected with the transceiver and the memory to receive a selection input of a user for one or more items, provide first benefit information related to the one or more items, and provide a page related to subscription of a specific membership in response to reception of an input related to the first benefit information based on account information of the user not corresponding to the specific membership, and the first benefit information may include first discount information that is provided based on the account information of the user corresponding to the specific membership.

The details of other example embodiments are included in the following detailed description and the accompanying drawings.

### Effects

According to the present disclosure, a system and method for processing item sales information may guide a user who does not have a membership to sign up for the membership by exposing membership benefits to the user and may guide a user who has a membership to maintain the membership by exposing membership benefits to the user.

The effects of the present disclosure are not limited to those described above and other effects may be made apparent to those skilled in the art from the following description.

### BRIEF DESCRIPTION OF THE DRAWINGS

FIG. 1 is a schematic configuration diagram showing a system for processing item sales information according to an example embodiment.

FIG. 2 is an operational flowchart of an information processing method of an electronic apparatus in the system for processing item sales information according to an example embodiment.

FIG. 3 is an exemplary diagram showing an operation of an electronic apparatus for providing first benefit information related to an item when account information of a user according to an example embodiment does not correspond to a specific membership.

FIG. 4 is an exemplary diagram showing an operation of an electronic apparatus for providing first benefit information related to an item when account information of a user according to an example embodiment corresponds to a specific membership.

FIG. 5 is an exemplary diagram showing an operation of an electronic apparatus for providing second benefit information related to an item in accordance with an example embodiment.

FIG. 6 is an exemplary diagram showing an operation of an electronic apparatus for providing a page related to membership subscription in response to reception of an input related to first benefit information in accordance with an example embodiment.

FIG. 7 is an exemplary diagram showing an operation of an electronic apparatus for providing additional descriptive information including first benefit information in response to reception of an input related to the first benefit information in accordance with an example embodiment.

FIG. 8 is an exemplary diagram showing an operation of an electronic apparatus for providing an item search result corresponding to a search input of a user in accordance with an example embodiment.

FIG. 9 is an exemplary diagram of the configuration of an electronic apparatus for processing item sales information according to an example embodiment.

### DETAILED DESCRIPTION

General terms that are currently widely used are selected as terms used in example embodiments in consideration of functions in the present disclosure but may be changed depending on the intention of those skilled in the art or a judicial precedent, the emergence of a new technique, and the like. In addition, in specific cases, there may be terms arbitrarily chosen by the applicant. In this case, the meaning of such a term will be described in detail in a corresponding description portion. Therefore, the terms used in the present disclosure should be defined on the basis of the meanings of the terms and the content throughout the present disclosure rather than the simple names of the terms.

Throughout the specification, unless otherwise designated, “including” any component means that other components may be further included rather than excluding other components. In addition, the terms “unit,” “module,” and the like, described in the specification refer to a processing unit of at least one function or operation and may be implemented by hardware or software or a combination of hardware and software.

The expression “at least one of a, b, and c” described throughout the specification may include “a alone,” “b alone,” “c alone,” “a and b,” “a and c,” “b and c,” or “all of a, b, and c.”

A “terminal” described below may be implemented as a computer or a portable terminal that may access a server or other terminals through a network. Here, computers may include, for example, a notebook computer, a desktop computer, a laptop computer, and the like, which are equipped with a web browser, and portable terminals are wireless communication devices that ensure portability and mobility, and may include, for example, all kinds of handheld-based wireless communication devices such as a communication-based terminal, a smartphone, and a tablet personal computer (PC) which support International Mobile Telecommunications (IMT), code division multiple access (CDMA), W-code division multiple access (W-CDMA), Long Term Evolution (LTE), etc.

Hereinafter, example embodiments of the present disclosure will be described in detail with reference to the accompanying drawings so that those skilled in the art to which the present disclosure pertains may easily practice the present disclosure. However, the present disclosure may be implemented in various different forms and is not limited to the example embodiments described herein.

Hereinafter, example embodiments of the present disclosure will be described in detail with reference to the drawings.

In describing the example embodiments, descriptions of technical contents that are well known in the technical field to which the present disclosure pertains and are not directly related to the present disclosure will be omitted. This is to more clearly convey the gist of the present disclosure without ambiguity by omitting unnecessary descriptions.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods accomplishing them will become apparent from the example embodiments to be described in detail below with reference to the accompanying drawings. However, the present disclosure is not limited to the example embodiments to be described below but may be implemented in various different forms, these example embodiments will be provided only in order to make the present disclosure complete and allow those skilled in the art to completely recognize the scope of the present disclosure, and the present disclosure will be defined by the scope of the claims. Throughout the specification, like reference numerals denote like components.

In this case, it will be appreciated that each block of a processing flowchart and combinations of the flowcharts may be executed by computer program instructions. Since these computer program instructions may be installed in a processor of a general computer, a special purpose computer, or other programmable data processing apparatuses, these computer program instructions executed through the processing of the computer or the other programmable data processing apparatuses create a means for performing functions described in the block(s) of the flowchart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including an instruction means for performing the functions described in the block(s) of the flowchart. Since the computer program instructions may also be installed in the computer or the other programmable data processing apparatuses, the instructions perform a series of operation steps on the computer or the other programmable data processing apparatuses to create processes executed by the computer, thereby running the computer or the other programmable data processing apparatuses may also provide operations for performing the functions described in the block(s) of the flowchart.

In addition, each block may indicate some of modules, segments, or codes including one or more executable instructions for executing a specific logical function (s). Further, it is to be noted that functions mentioned in the blocks occur regardless of a sequence in some alternative example embodiments. For example, two blocks that are consecutively shown may in fact be simultaneously performed or performed in a reverse sequence depending on corresponding functions.

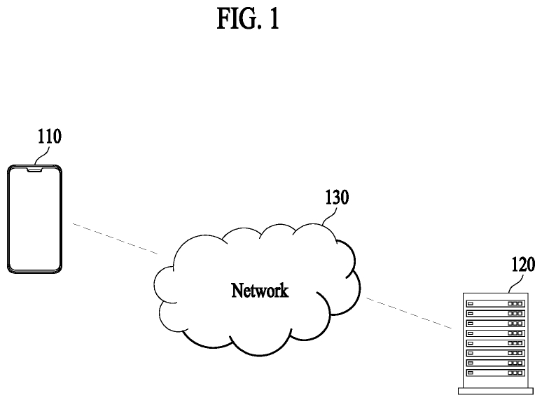

FIG. 1 is a schematic configuration diagram showing a system for processing item sales information according to an example embodiment.

According to various embodiments, a system for processing item sales information may include an electronic apparatus 110 and a user terminal 120. In some embodiments, the system for processing item sales information may further include at least one of a first server and a second server (not shown in the drawings). In some embodiments, the system for processing item sales information may further include a network 130 for supporting information transmission/reception among at least some of the electronic apparatus 110, the user terminal 120, the first server, and the second server.

The electronic apparatus 110, the user terminal 120, the first server, and the second server may each include a transceiver, a memory, and a processor. The electronic apparatus 110, the user terminal 120, the first server, and the second server may each refer to a unit that processes at least one function or operation and may be implemented by hardware, software, or a combination of hardware and software. Although the electronic apparatus 110, the user terminal 120, the first server, and the second server are noted as separate devices or servers throughout the example embodiment, they may be logically separate structures and may be implemented by separate functions in one server.

According to an example embodiment, the electronic apparatus 110, the user terminal 120, the first server, and the second server may include several computer systems or computer software implemented as network servers. For example, at least some of the electronic apparatus 110, the user terminal 120, the first server, and the second server may be referred to as computer systems or computer software that is connected with a lower-level device being able to communicate with another network server through a computer network such as an intranet or the Internet, receives a request for performing a task, and provides a performance result by performing the corresponding task. Further, at least some of the electronic apparatus 110, the user terminal 120, the first server, and the second server may be understood in a broad sense as a concept including a series of application programs, which may be executed on a network server, and various databases constructed inside. For example, at least some of the electronic apparatus 110, the user terminal 120, the first server, and the second server may be implemented using network server programs that are variously provided in accordance with operating systems such as DOS, Windows, Linux, UNIX, or MacOS.

The electronic apparatus 110 may be a device for managing a website for online e-commerce. The electronic apparatus 110 may configure and provide various types of information to the user terminal 120 as a webpage on a website. In detail, the electronic apparatus 110 may be a device serving to provide various types of information related to item sales to the user terminal 120.

The electronic apparatus 110 receives a selection input of a user for one or more items. The electronic apparatus 110 receiving the selection input of a user provides first benefit information related to the one or more items. First benefit information includes first discount information that is provided when account information of a user corresponds to a specific membership. The first discount information may include a discount benefit or a point accumulation benefit related to the purchase of specific items. The first discount information may include at least one of a benefit that is provided from a website managed by the electronic apparatus 110 itself and a benefit that is provided by the second server that is a server corresponding to a specific payment method. Meanwhile, in an example embodiment, the specifics stated as discount information may include benefit information such as free delivery, free return, and specific-time delivery according to the purchase of products. Such benefits enable a user to save money on the procedure of purchasing products.

When the account information of a user does not correspond to a specific membership, the electronic apparatus 110 provides a page related to membership subscription in response to reception of an input related to the first benefit information. The page related to membership subscription may show membership benefits and may progress membership registration of the user's account in accordance with an additional input of the user.

The electronic apparatus 110 may provide a payment page for purchasing and paying for one or more items to a user and may process a transaction in accordance with a corresponding input of the user. In detail, when an item is purchased using a specific payment method, the electronic apparatus 110 may transmit a request for paying the price of the item to the second server and may transmit a request for dispatching and delivering the item to the first server.

The payment page provided by the electronic apparatus 110 may include a price to which the first discount information has been applied. According to an example embodiment, when the first discount information is a benefit that is applied when one or more items are purchased using a specific payment method and the account information of a user corresponds to a specific membership, the electronic apparatus 110 may provide a payment page that includes the price, to which the first discount information has been applied in relation to at least some of the one or more items, and on which the specific payment method is set as a payment method for paying for at least some of the one or more items in response to reception of an input related to the first benefit information. In this case, the payment request that is transmitted from the electronic apparatus 110 to the second server may be a payment request for the price of an item to which the first discount information has been applied.

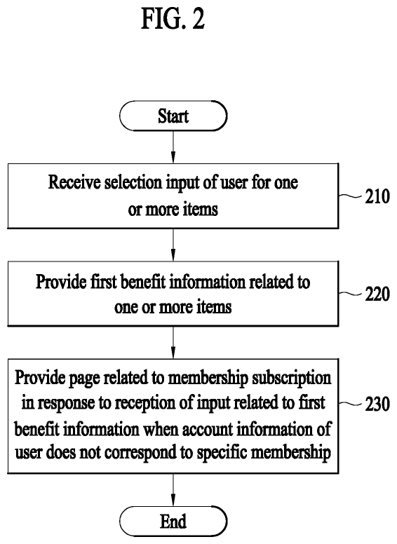

More detailed specifics related to a method of processing item sale information in the electronic apparatus 110 will be described with reference to FIG. 2.

The user terminal 120 may be a device for a user to purchase items through an e-commerce website. The user terminal 120 may be implemented as a computer or a portable terminal that may transmit/receive various types of information to/from the electronic apparatus 110 through the network 130. The user terminal 120 may provide information received from the electronic apparatus 110 to a user and may receive an input from a user and transmit the input to the electronic apparatus 110. In detail, the user terminal 120 may receive and transmit a selection input of a user for one or more items to the electronic apparatus 110 and receive first benefit information from the electronic apparatus 110, which is provided through a screen, etc. When receiving a page related to membership subscription from the electronic apparatus 110 or receiving a request to output a page related to membership subscription from the electronic apparatus 110, the user terminal 120 may output the page related to membership subscription.

An input that is received from a user may include various types of inputs such as a click through a mouse, a touch through a touch pad or a touch screen, voice recognition, and other electronic inputs.

The first server may be a server that is managed by a distribution center for storing and delivering items that are purchased online. The first server that receives a request for dispatch and delivery may gather at least some of items and get the same ready for delivery. In relation to this, the first sever may perform delivery to the address received from the electronic apparatus 110. Further, the first server may perform operations such as managing the stock in a distribution center and checking the work statuses of workers related to dispatch and delivery in order to finish delivering items within a predetermined time without an omission. Furthermore, the first sever may further check whether the second server has paid an item's price in some embodiments.

The second server may be a server corresponding to a specific payment method. According to an example embodiment, the second server may correspond to a server that is managed at a specific financial institution. For example, the second server may correspond to a server that is managed at XX Bank. According to an example embodiment, the first discount information may be a benefit that is provided by the second server.

According to an example embodiment, the payment method may correspond to a payment amount transfer based on an account that is managed by the second server. According to an example embodiment, the payment method may correspond to a payment using a card issued by a card company to which the second server corresponds. According to an example embodiment, the payment method may correspond to a mobile phone payment. Further, the payment method may include a wide range of payment methods without being limited to a specific method.

The second server receiving a payment request from the electronic apparatus 110 may determine whether the account information included in the payment request is valid and may determine whether the balance in the account corresponding to the account information is greater than or equal to an amount requested to be paid. According to the determination result, the second server may pay the electronic apparatus 110 the payment amount or may transmit payment failure information to the electronic apparatus 110.

According to an example embodiment, when first benefit information includes a plurality of different benefits that are provided for a plurality of payment methods, respectively, there may be servers corresponding to the payment methods. In this case, the system for processing item sales information may include a plurality of different servers corresponding to a plurality of payment methods. However, in this case, the operational manner of each of the servers may correspond to the operational manner of the second server. Accordingly, hereinafter, servers corresponding to payment methods may be limited to the second server for convenience of description and the description about the second server may be applied in the same way to other servers corresponding to different payment methods, respectively.

The network 130 may serve to connect the electronic apparatus 110 to the user terminal 120, the first server, the second server, or other external devices. For example, the network 130 may provide a connection path so that the user terminal 120 is connected with the electronic apparatus 110 and may transmit/receive packet data to/from the electronic apparatus 110.

Operations related to the method of processing a series of item sales information according to various example embodiments may be implemented by a single physical device or may be implemented by organically combining a plurality of physical devices. For example, some of the components included in the system for processing item sales information may be implemented by any one physical device and some of the others may be implemented by another physical device. For example, any one physical device may be implemented as a part of the electronic apparatus 110 and another physical device may be implemented as a part of the user terminal 120 or a part of the first server or a part of the second server or a part of external devices. In some cases, the components included in the system for processing item sales information may be distributed in different physical devices and the distributed components may be organically combined to perform the functions and operations of the system for processing item sales information. For example, the electronic apparatus 110 of the present disclosure may include at least one sub-device and some operations described as being performed by the electronic apparatus 110 may be performed by a first sub-device and other operations may be performed by a second sub-device.

FIG. 2 is an operational flowchart of an information processing method of an electronic apparatus in the system for processing item sales information according to an example embodiment.

Referring to FIG. 2, in operation 210, the electronic apparatus 110 according to the example embodiment receives a selection input of a user for one or more items. As described above, the electronic apparatus 110 receiving the selection input of a user provides first benefit information related to the one or more items in operation 220. The first benefit information includes first discount information that is provided when account information of the user corresponds to a specific membership. The first benefit information may include information indicating that first discount information is provided when the account information of the user corresponds to a specific membership.

The first benefit information may include benefits for providing user convenience in relation to the purchase of specific items in addition to the first discount information including a discount benefit or a point accumulation benefit related to the purchase of specific items. For example, the first benefit information may include delivery-related benefit information corresponding to a specific membership (for example, a benefit that secures free delivery or free return without a condition when specific items are purchased).

According to an example embodiment, the electronic apparatus 110 receiving selection information of a user may provide second benefit information which is irrelevant to a specific membership and including second discount information related to one or more items. In this case, the first benefit information and the second benefit information may be displayed in a first region. According to an example embodiment, the second benefit information may be displayed at a lower level than the first benefit information. Accordingly, the first benefit information is more conspicuous, whereby it is possible to guide a user to sign up for a membership or more effectively show the membership benefits.

According to an example embodiment, the first discount information may correspond to a benefit that is better than the second discount information, whereby it is possible to guide a user to sign up for a membership.

In relation to this, the electronic apparatus 110 may further perform an operation of determining whether to provide the second benefit information. In detail, when the first discount information and the second discount information may be simultaneously applied to purchase one or more items, the electronic apparatus 110 may determine to provide the second benefit information. On the contrary, when the first discount information and the second discount information may not be simultaneously applied to purchase one or more items, the electronic apparatus 110 may determine to provide the second benefit information only when determining that the account information of a user does not correspond to a specific membership. That is, when the first discount information and the second discount information may not be simultaneously applied to purchase one or more items, the electronic apparatus 110 may determine not to provide the second benefit information when determining that the account information of a user corresponds to a specific membership.

However, in some embodiments, even though the first discount information and the second discount information may not be simultaneously applied to purchase one or more items and the account information of a user corresponds to a specific membership, the electronic apparatus 110 may provide the second benefit information. For example, when it is difficult to quantitatively compare the first discount information and the second discount information (for example, the first discount information corresponds to a 5% discount of a payment amount and the second discount information corresponds to a benefit that provides a predetermined gift) or when the second discount information corresponds to a benefit that is quantitatively better than the first discount information (for example, the first discount information corresponds to a 5% discount of a payment amount and the second discount information corresponds to a 7% discount of the payment amount), the electronic apparatus 110 may provide the second benefit information. Alternatively, when a user does not have a payment method related to the first discount information or whether the user has the payment method is not clear, the second benefit information may be provided so as to enable the user to receive the second discount information when the user does not receive the first discount information. Whether a user has a payment method related to the first discount information may be determined with reference to at least one payment method stored in advance in correspondence with the account information of the user.

When the first benefit information includes a plurality of different benefits that are provided for a plurality of payment methods, the electronic apparatus 110 may determine the manner of displaying the different benefits on the basis of the result of comparing at least some of the different benefits. As an example, the electronic apparatus 110 may display a plurality of different benefits in order of higher discount ratio. Alternatively, the electronic apparatus 110 may preferentially display the benefit corresponding to the payment method that a user has and may display benefits corresponding to payment methods that the user does not have thereunder. Further, a manner of displaying a plurality of different benefits may be determined on the basis of various criteria.

When the first benefit information includes one or more benefits that are provided for one or more payment methods, the electronic apparatus 110 may determine whether to provide or not provide at least some of the first benefit information in consideration of payment methods. In detail, when there is at least one benefit related to at least one payment method stored in advance in correspondence with user account information among one or more benefits that are provided for payment methods, the electronic apparatus 110 may provide at least one corresponding benefit. However, when there is no at least one benefit related to at least one payment method stored in advance, the electronic apparatus 110 may not provide the first benefit information.

For example, when the first benefit information includes information about a benefit that provides a 5% discount of a payment amount when an AA card is used for payment and a benefit that provides a 7% discount of a payment amount when a BB card is used for payment, and when the payment method stored in advance in correspondence with the account information of a user is a BB card or a CC card, the electronic apparatus may provide information including that a 7% discount of a payment amount is provided when a BB card is used for payment. Further, when there is only a CC card stored in advance in correspondence with the account information of the user, the electronic apparatus 110 may not provide the first benefit information.

When first benefit information includes one or more benefits to which a specific budget has been allocated to provide the benefits, the electronic apparatus 110 may determine whether to provide or not provide at least some of the first benefit information in consideration of the balance of the budget. In detail, the electronic apparatus 110 may check the balance of the budget allocated to provide the first benefit information, provide item-related information to which the first benefit information has been applied when the balance satisfies a specific condition, and provide the item-related information to which the first benefit information has not been applied when the balance does not satisfy the specific information. For example, when the first benefit information is that an AA card company provides a benefit of discounting a payment amount by 10% when a specific item is paid for using an AA card and a budget of 100 million won has been funded for this case, and when the specific condition corresponds to whether the balance is sufficient for providing the first benefit information, the electronic apparatus 110 may check the balance of the budget and whether the balance is sufficient for providing the first benefit information every time a specific item is paid for. For example, when the price of a specific item is 1 million won and there is an input for selecting the specific item and paying for 100 items, the balance should be greater than or equal to 10 million won which is calculated from “(1 million/EA)*(100 items)*(10/100).

The selection input of a user that the electronic apparatus 110 receives may be input for inquiring about detailed information on or regarding one or more items. Alternatively, the selection input of a user may be an input for a request to purchase one or more items. Alternatively, the selection input of a user may be an input for showing an intention to purchase of one or more items and adding the one or more items to a shopping cart list.

According to an example embodiment, the electronic apparatus 110 may receive a search input of a user and provide an item search result in response to the search input of a user. In this case, a selection input of the user may be received in response to the search result provided by the electronic apparatus 110 (corresponding to operation 210). In this case, the search result provided by the electronic apparatus 110 may include first benefit information. For example, when an item search result includes first item-related information and the first item is related to first benefit information, the first item-related information may include the first benefit information.

The electronic apparatus 110 may provide the first benefit information on a page showing detailed information about one or more items. Alternatively, the electronic apparatus 110 may provide the first benefit information on a payment page. Alternatively, the electronic apparatus 110 may provide the first benefit information on a shopping cart list corresponding to one or more items on which a user shows an intention to purchase.

When the account information of a user does not correspond to a specific membership, in operation 230, the electronic apparatus 110 provides a page related to membership subscription in response to reception of an input related to the first benefit information.

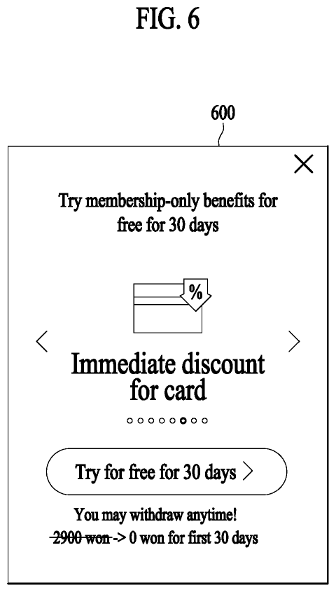

An example of a page related to membership subscription will be described below with reference to FIG. 6.

When the account information of a user corresponds to a specific membership, the electronic apparatus 110 may provide additional descriptive information including the first benefit information in response to reception of an input related to the first benefit information. The additional descriptive information may include various types of benefit information related to one or more items. For example, the additional descriptive information may include a detailed description related to the second benefit information in addition to the first benefit information.

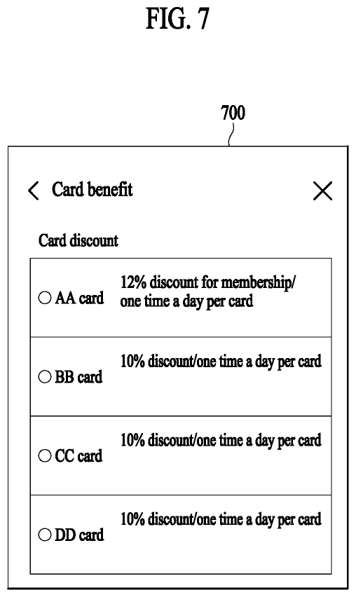

An example of the additional descriptive information will be described below with reference to FIG. 7.

According to an example embodiment, when a user signs up for a specific membership on the basis of a page related to subscription of the specific membership, the electronic apparatus 110 may provide a benefit of a reduction or exemption of a usage fee for the specific membership to the user for a predetermined period. For example, when a user signs up for a specific membership on the basis of a page related to subscription of the specific membership, the electronic apparatus 110 may provide a benefit to a user such that the user may use the membership for free for 30 days after subscription. Meanwhile, the period for a reduction or exemption in an example embodiment may be determined on the basis of service use history information of a user, and for example, a longer reduction or exemption period may be provided to a user who has a lot of actual experience of using services on the basis of a service use history.

According to an example embodiment, when a user signs up for a specific membership on the basis of a page related to subscription of the specific membership, the electronic apparatus 110 may further determine whether the user has been provided a benefit of a reduction or exemption of a usage fee for the specific membership. When the user has not been provided the benefit of a reduction or exemption as the result of determination, the electronic apparatus 110 may provide the benefit of a reduction or exemption to the user. However, when the user has been provided the benefit of a reduction or exemption as the result of determination, the electronic apparatus 110 may not provide the benefit of a reduction or exemption to the user again. By not repeatedly providing a user a benefit of a reduction or exemption related to membership subscription, an abuse of the reduction or exemption benefit may be prevented.

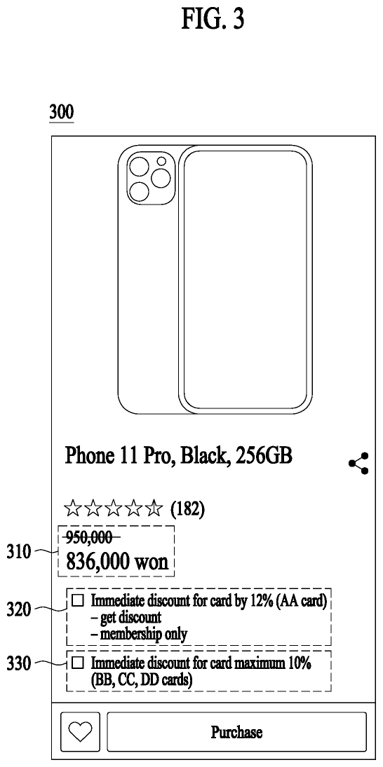

FIG. 3 is an exemplary diagram showing an operation of an electronic apparatus for providing first benefit information related to an item when account information of a user according to an example embodiment does not correspond to a specific membership.

Referring to FIG. 3, when the account information of a user according to an example embodiment does not correspond to a specific membership, the electronic apparatus 110 may provide first benefit information indicated by reference numeral 300. First discount information according to an example embodiment may include a discount benefit related to purchase of specific items. For example, an example of the first benefit information indicated by reference numeral 320 may include a message “immediate discount of 12% for card.”

The first discount information according to an example embodiment may correspond to at least one benefit related to at least one payment method stored in advance in the account information of a user. For example, an example of the first benefit information indicated by reference numeral 320 may include a message for a benefit that is provided when an AA card is used for payment.

Further, it may be noted that the first benefit information is provided when the account information of a user corresponds to a specific membership. For example, an example of the first benefit information indicated by reference numeral 320 may include a message “only for members.” Further, the first benefit information may further include a message such as “get discount” to guide an input from a user in relation to the first benefit information. When receiving an input of a user for the first benefit information, the electronic apparatus 110 may provide a page related to subscription of a specific membership in response to reception of the input.

According to an example embodiment, when the first benefit information includes a discount benefit related to purchase of specific items, the electronic apparatus 110 providing the first benefit information may provide price information to which the first discount information has been applied. In relation to this, the electronic apparatus 110 may provide price information to which the first discount information has been applied for at least some of one or more items regardless of whether the account information of a user corresponds to a specific membership. For example, FIG. 3 shows an example embodiment related to the case in which the account information of a user does not correspond to a specific membership, but price information (e.g., 836,000 won) to which the first discount information has been applied may be provided, as indicated by reference numeral 310.

According to an example embodiment, when the first benefit information includes a discount benefit related to purchase of specific items, the electronic apparatus 110 providing the first benefit information may provide price information to which the first discount information has not been applied. In this case, the electronic apparatus 110 may provide only price information to which the first discount information has not been applied and may provide both of the price information to which the first discount information has been applied and price information to which the first discount information has not been applied. For example, an example of price information indicated by reference numeral 310 may provide price information to which the first discount information has been applied and price information to which the first discount information has not been applied, such as “836,000 won.”

According to an example embodiment, the electronic apparatus 110 may provide second discount information which is irrelevant to a specific membership and related to one or more items in addition to the first benefit information. For example, an example of the second benefit information indicated by reference numeral 330 may include a message for a benefit that is provided when an AA card is used for payment.

In an example embodiment, when a user corresponds to a specific membership, the electronic apparatus 110 may additionally provide benefit information related to delivery together with information indicating that the user has the specific membership. For example, the electronic apparatus 110 may provide information about that the user has the membership, delivery at a specific time period is possible, free delivery is possible, free return is possible, and delivery of fresh food is possible to the user.

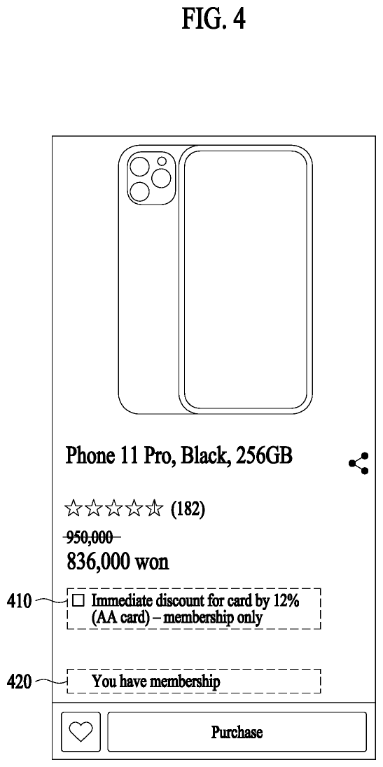

FIG. 4 is an exemplary diagram showing an operation of an electronic apparatus for providing first benefit information related to an item when account information of a user according to an example embodiment corresponds to a specific membership.

Referring to FIG. 4, when the account information of a user according to an example embodiment corresponds to a specific membership, the electronic apparatus 110 may provide first benefit information. First discount information according to an example embodiment may include a discount benefit related to purchase of specific items. For example, an example of the first benefit information indicated by reference numeral 410 may include a message “immediate discount of 12% for card.”

When the account information of a user corresponds to a specific membership, the first benefit information may include information indicating that the account information of the user corresponds to the specific membership. For example, an example of the information indicating correspondence to a specific membership indicated by reference numeral 420 may include a message “you have a membership.”

As described above with reference to FIG. 3, the electronic apparatus 110 may provide price information to which the first discount information has been applied for at least some of one or more items regardless of whether the account information of a user corresponds to a specific membership. For example, referring to FIG. 4, in an example embodiment in which the account information of a user corresponds to a specific membership, the electronic apparatus 110 may provide price information (e.g., 836,000 won) to which first discount information has been applied.

As described above with reference to FIG. 2, the electronic apparatus 110 receiving selection information of a user may further perform an operation of determining whether to provide second benefit information which is irrelevant to the specific membership and including second discount information related to one or more items. According to the example information, when the first discount information and the second discount information may not be simultaneously applied to purchase one or more items, the electronic apparatus 110 may determine to provide the second benefit information only when determining that the account information of a user does not correspond to a specific membership. In this case, the second benefit information may not be provided when the account information of a user corresponds to a specific membership. Meanwhile in an example embodiment, the second benefit information may be displayed at a lower level than the first discount information.

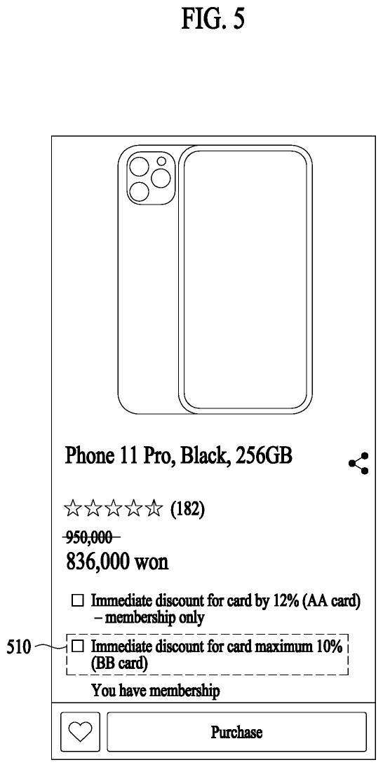

However, as described above with reference to FIG. 2, in some embodiments, even though the first discount information and the second discount information may not be simultaneously applied to purchase one or more items and the account information of a user corresponds to a specific membership, the electronic apparatus 110 may provide the second benefit information. As an example, when the second discount information corresponds to a benefit that is quantitatively better than the first discount information, the electronic apparatus 110 may provide the second benefit information. In relation to this, referring to FIG. 5, when second discount information according to an example embodiment corresponds to a benefit that provides a discount of 15% of a payment amount when a BB card is used as a payment method, the benefit corresponds to a benefit that is quantitatively better than first discount information (e.g., a discount of 12% of a payment amount), so the electronic apparatus 110 may provide second benefit information 510.

FIG. 6 is an exemplary diagram showing an operation of an electronic apparatus for providing a page related to membership subscription in response to reception of an input related to first benefit information in accordance with an example embodiment.

Referring to FIG. 6, the electronic apparatus 110 according to the example embodiment provides a page related to membership subscription in response to reception of an input related to the first benefit information as indicated by reference numeral 600. The page related to membership subscription may show membership benefits and progress membership registration of the user's account in accordance with an additional input of the user. For example, the page related to membership subscription may show at least some of various benefits including an additional discount benefit for some items, a benefit securing free delivery, a benefit securing free return, a benefit providing item delivery at a specific time period, a benefit providing items corresponding to fresh food, and a benefit of point accumulation.

Further, the electronic apparatus 110 may progress membership registration of a user account in accordance with an input corresponding to membership subscription of the user. An example of an input corresponding to membership subscription may be a user interface (UI) including a message “free trial for 30 days” or “join.”

According to an example embodiment, in order to reduce the entry barrier of a user for membership, the electronic apparatus 110 may provide a membership benefit such as free membership for a predetermined period after subscription or may secure the right of a user to terminate membership at any desired time. Further, the electronic apparatus 110 may disclose the contents on a page related to membership subscription. For example, the page related to membership subscription may include messages “free trial for 30 days,” “you may terminate anytime,” “→0 won for first 30 days,” etc.

According to an example embodiment, when the page related to a specific membership is related to one or more items corresponding to a selection input of a user and the account information of a user corresponds to a specific membership, the page may include information about at least one item whose price is discounted. For example, when a selection input of a user for an item corresponding to one box of apples is received, first benefit information related to the item is provided, and a page related to subscription of a specific membership is provided in response to reception of an input related to the first benefit information, the page related to the specific membership may include information about items (e.g., one pack of strawberries) to which a discount is provided by the specific membership among items of fruits pertaining to the same category as the one box of apples.

FIG. 7 is an exemplary diagram showing an operation of an electronic apparatus for providing additional descriptive information including first benefit information in response to reception of an input related to the first benefit information in accordance with an example embodiment.

Referring to FIG. 7, when the account information of a user according to an example embodiment corresponds to a specific membership, the electronic apparatus 110 may provide additional descriptive information including the first benefit information in response to reception of an input related to the first benefit information as indicated by reference numeral 700. The additional descriptive information may include various types of benefit information related to one or more items. For example, the additional descriptive information may show second benefit information irrelevant to the membership such as a BB card, a CC card, and a DD card in addition to the discount benefit information about an AA card corresponding to the first benefit information. Further, in some embodiments, the additional descriptive information may further include additional information such as the period (for example, one time a day per card) for which a benefit may be provided in relation to benefit information.

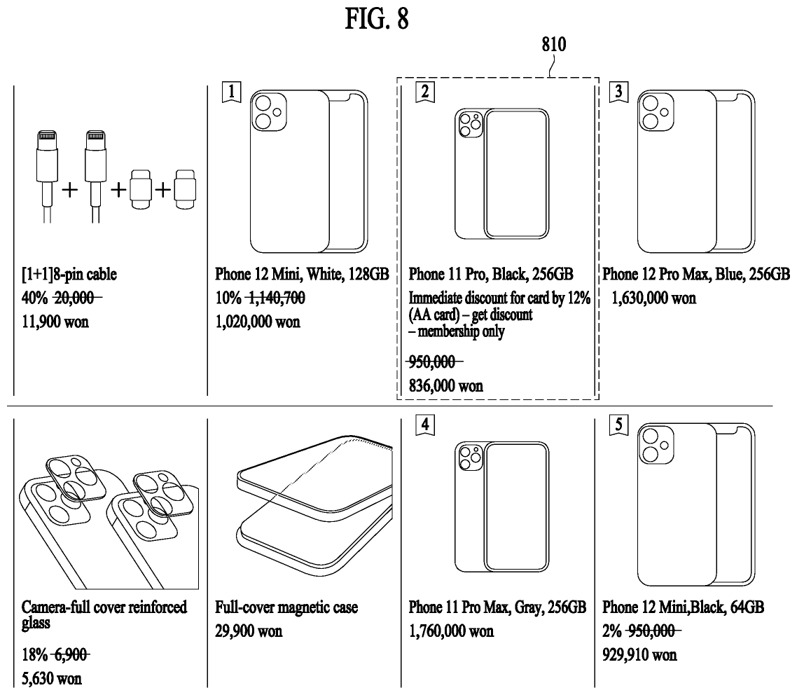

FIG. 8 is an exemplary diagram showing an operation of an electronic apparatus for providing an item search result in response to a search input of a user in accordance with an example embodiment.

Referring to FIG. 8, the electronic apparatus 110 according to the example embodiment may receive a search input of a user and may provide the item search result in response to the search input of a user. In this case, a selection input of the user may be received in response to the search result provided by the electronic apparatus 110.

The search result provided by the electronic apparatus 110 may include first benefit information. In detail, when an item search result includes first item-related information and the first item is related to first benefit information, the first item-related information may include the first benefit information, etc. For example, reference numeral 810 may correspond to first benefit information and item information including price information to which first discount information has been applied. In some embodiments, the item information may include price information before the first discount information is applied. Further, in some embodiments, the item information may include second benefit information or price information to which second discount information has been applied.

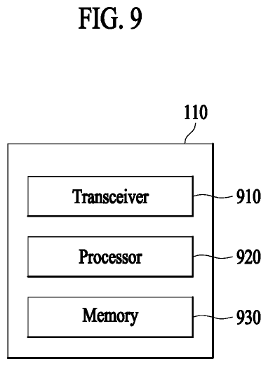

FIG. 9 is an exemplary diagram of the configuration of an electronic apparatus for processing item sales information according to an example embodiment.

Referring to FIG. 9, the electronic apparatus 110 includes a transceiver 910, a processor 920, and a memory 930. The electronic apparatus 110 may be connected with the user terminal 120, the first server, the second server, and other external devices through the transceiver 910 and may exchange data.

The processor 920 may include at least one device described with reference to FIGS. 1 to 8 and perform at least one method described with reference to FIGS. 1 to 8. The memory 930 may store information for performing the method described with reference to FIGS. 1 to 8. The memory 930 may include a volatile memory or a nonvolatile memory.

The processor 920 may execute programs and control the electronic apparatus 110 for providing information. The code of the programs that are executed by the processor 920 may be stored in the memory 930.

The electronic apparatus 110 according to the example embodiment may include a UI that may provide information to a user.

As described above, the example embodiments of the present disclosure have been disclosed in the specification and drawings, but it should be understood that the example embodiments are merely used for easily describing the present disclosure and helping the understanding of the present disclosure without limiting the scope of the present disclosure. It is apparent to those skilled in the art that the present disclosure may be modified in various ways on the basis of the spirit of the present disclosure other than the example embodiments described herein.

The electronic apparatus or the terminal according to the example embodiments described above may include a processor, a permanent storage such as a memory and a disc drive for storing and executing program data, a communication port communicating with external devices, and a UI device such as a touch panel a key, and a button. Methods that are implemented by software modules and algorithms may be stored on a computer-readable recording medium as computer-readable code or programs that may be executed on the processor. The computer-readable recording medium may be a magnetic storage medium (for example, a read-only memory (ROM), a random-access memory (RAM), a floppy disk, a hard disc, etc.), and an optical read-out medium (for example, a compact disk (CD)-ROM and a digital versatile disc (DVD)). Further, the computer-readable recording media may be distributed over computer systems that are connected through a network and may store and execute computer-readable code in a distributed manner. The medium may be readable by a computer, may be stored in a memory, and may be executed by a processor.

The example embodiment may be implemented by functional block configurations and various processing operations. Such functional blocks may be implemented by various hardware or/and software configurations that perform specific functions. For example, the example embodiment may employ integrated circuit configurations such as a memory, a processor, a logic, a look-up table that may perform various functions under control by one or more microprocessors or other controllers. Similarly to components that may be implemented by software programming or software elements, example embodiments may include various algorithms implemented by a data architecture, processes, routines, or a combination of other programming configurations, and may be implemented by a programming or scripting language such as C, C++, Java, and assembler. Functional terms may be implemented by an algorithm that is executed by one or more processors. Further, the example embodiment may employ the related art for electronic environment setting, signal processing, and/or data processing. Terms such as “mechanism,” “element,” “part,” and “configuration” may be widely used and are not limited to mechanical and physical configurations. The terms may include the meaning of a series of routines of software in relation to a processor, etc.

The embodiments described above are only exemplary and other example embodiments may be implemented within the range of claims.

1. A method of processing item sales information by an electronic apparatus, the method comprising:
receiving, by a transceiver of the electronic apparatus, data indicative of a selection input of a user for one or more items, the received data including account information related to the user, the account information including data related to a payment method associated with the user for an item sales service provided via the electronic apparatus;
determining a balance of a monetary budget allocated for funding each of one or more discounts related to the one or more items;
identifying at least one discount among the one or more discounts, wherein the at least one discount is based on a monetary budget with a balance for funding the at least one discount being equal to or more than a predetermined amount;
transmitting, by the transceiver to a terminal in data communication with the electronic apparatus, data regarding the at least one discount related to the one or more items;
providing, based on a) determining that the account information related to the user does not include data indicative of a membership associated with the at least one discount and b) receiving, by the transceiver, data indicative of an input of the user which corresponds to the at least one discount, a page related to subscribing to the membership to be displayed on a user interface (UI) of the terminal, the page including a personalized membership benefit and a link, wherein the link directs the user to a menu for the steps for subscribing to the membership, wherein the personalized membership benefit is automatically generated based on a usage history of the item sales service related to the user; and
cooperating with a first server and a second server to process a request for sale and delivery of at least one of the one or more items based on a user input received through the UI of the terminal, wherein the first server is configured for management of delivery of the one or more items from a distribution center, wherein the second server is configured for management and processing of payment for the one or more items.

2. The method of claim 1, wherein, based on the account information of the user corresponding to the membership, the at least one discount includes information indicating that the account information of the user corresponds to the membership and delivery-related benefit information corresponding to the specific membership.

3. The method of claim 1, wherein the at least one discount includes information indicating that the personalized membership benefit is provided based on the account information of the user corresponding to the membership.

4. The method of claim 1, further comprising:
providing benefit information which is irrelevant to the membership and includes discount information related to the one or more items,
wherein the at least one discount and the benefit information are displayed in a first region and the second benefit information is displayed at a lower level than the at least one discount.

5. The method of claim 1, further comprising:
providing additional descriptive information including the at least one discount in response to the reception of the input related to the at least one discount based on the account information of the user corresponding to the membership.

6. The method of claim 1, further comprising:
providing a payment page including a price, to which the at least one discount has been applied, in relation to at least one of the one or more items in response to the reception of the input related to the personalized membership benefit based on the account information of the user corresponding to the membership.

7. The method of claim 1, further comprising:
providing a payment page that includes a price to which the personalized membership benefit has been applied in relation to at least one of the one or more items, and on which a specific payment method is set as a payment method for paying for at least some of the one or more items, in response to the reception of the input related to the at least one discount based on the personalized membership benefit being a benefit that is applied based on the one or more items being purchased using the specific payment method and the account information of the user corresponding to the membership.

8. The method of claim 1, wherein the at least one discount corresponds to at least one benefit related to at least one payment method stored in advance in the account information of the user.

9. The method of claim 1, further comprising:
providing price information to which the at least one discount has been applied for at least one of the one or more items regardless of the account information of the user corresponding to the membership.

10. The method of claim 1, further comprising:
receiving a search input of a user; and
providing an item search result in response to the search input,
wherein, based on the item search result including information related to a first item and the first item being related to the at least one discount, the at least one discount related to the first item includes the personalized membership benefit.

11. The method of claim 1, further comprising:
checking a balance of a budget allocated to provide the at least one discount,
wherein item-related information to which the at least one discount has been applied is provided based on the balance satisfying a specific condition, and item-related information to which the at least one discount has not been applied is provided based on the balance not satisfying the specific condition.

12. The method of claim 1, wherein, based on the at least one discount including a plurality of different benefits that are provided for a plurality of payment methods, the transmitting of the data regarding the at least one discount includes determining a manner of showing the plurality of different benefits on a basis of a result comparing at least some of the plurality of different benefits.

13. The method of claim 1, wherein, based on the at least one discount including one or more benefits that are provided for one or more payment methods, the providing of the at least one discount includes providing at least one benefit based on the at least one benefit related to at least one payment method being stored in advance in correspondence with the account information of the user among the one or more benefits, and
based on no benefit related to at least one payment method being stored in advance in correspondence with the account information of the user among the plurality of different benefits, the at least one discount is not provided.

14. (canceled)

15. The method of claim 1, wherein the determining to provide the second benefit information includes:
determining to provide benefit information which is irrelevant to the membership and includes discount information related to the item;
determining that the benefit information is to be provided based on the at least one discount and the discount information being allowed to be simultaneously applied to purchase the one or more items; and
based on the at least one discount and the discount information not being allowed to be simultaneously applied to purchase the one or more items, determining that the benefit information is to be provided in response to a determination that the account information of the user does not correspond to the membership, and determining that the benefit information is not to be provided in response to a determination that the account information of the user corresponds to the membership.

16. The method of claim 1, further comprising:
providing a reduction or exemption benefit for a usage fee for the membership to the user for a predetermined period based on the user signing up for the membership on a basis of the page related to the subscription of the membership,
wherein the predetermined period is determined on a basis of history information of the user.

17. The method of claim 1, further comprising:
determining the user has not been provided with a reduction or exemption benefit for a usage fee for the membership based on the user signing up for the membership on a basis of the page related to the subscription of the membership; and
providing the reduction or exemption benefit to the user based on the user not having been provided with the reduction or exemption benefit,
wherein the reduction or exemption benefit is not provided to the user again based on the user being provided with the reduction or exemption benefit.

18. The method of claim 1, wherein the page related to the subscription of the membership includes information related to at least one item whose price is discounted based on the page being related to the one or more items and the account information of the user corresponding to the membership.

19. A non-transitory computer-readable recording medium on which programs for causing a computer to execute the method of claim 1 are recorded.

20. An electronic apparatus for selling items, the electronic apparatus comprising:
a transceiver;
a memory in which instructions are stored; and
a processor,
wherein the processor is connected with the transceiver and the memory to:
receive, by the transceiver, data indicative of a selection input of a user for one or more items, the received data including account information related to the user, the account information including data related to a payment method associated with the user for an item sales service provided via the electronic apparatus,
determine a balance of a monetary budget allocated for funding each of one or more discounts related to the one or more items;
identify at least one discount among the one or more discounts, wherein the at least one discount is based on a monetary budget with a balance for funding the at least one discount being equal to or more than a predetermined amount;
transmit, by the transceiver to a terminal in data communication with the electronic apparatus, data regarding the at least one discount related to the one or more items;
provide, based on a) determining that the account information related to the user does not include data indicative of a membership associated with the at least one discount and b) receiving, by the transceiver, data indicative of an input of a user which corresponds to the at least one discount, a page related to subscribing to the membership to be displayed on a user interface (UI) of the terminal, the page including a personalized membership benefit and a link, wherein the link directs the user to a menu for the steps for subscribing to the membership, wherein the personalized membership benefit is automatically generated based on a usage history of the item sales service related to the user,
wherein the first benefit information includes first discount information that is provided based on the account information of the user corresponding to the specific membership cooperate with a first server and a second server to process a request for sale and delivery of at least one of the one or more items based on a user input received through the UI of the terminal, wherein the first server is configured for management of delivery of the one or more items from a distribution center, wherein the second server is configured for management and processing of payment for the one or more items.

21. The method of claim 1, wherein the personalized membership benefit is a longer exemption or reduction period.
